(19) United States
(12) Patent Application Publication
(10) Pub. No.: US 2024/0039703 A1
(43) Pub. Date: Feb. 1, 2024

(54) METHODS, SYSTEMS, AND MODULES FOR KEY EXCHANGE IN POINT-TO-MULTIPOINT TRANSPORT NETWORKS

(71) Applicant: Infinera Corp., San Jose, CA (US)

(72) Inventors: Radhakrishna Valiveti, Union City, CA (US); Steven Joseph Hand, Los Gatos, CA (US); Rajan Rao, Fremont, CA (US)

(21) Appl. No.: 18/363,562

(22) Filed: Aug. 1, 2023

Related U.S. Application Data
(60) Provisional application No. 63/394,157, filed on Aug. 1, 2022.

(51) Int. Cl. H04L 9/08

(52) U.S. Cl. CPC H04L 9/0822; H04L 9/083

(57) ABSTRACT

Modules for hub network elements and methods are described, including a method comprising (a) generating a partial key indicative of a unique public key associated with a hub network element in a transport network, (b) sending a partial-key message comprising the partial key and an ordered sequence to a particular network element of the ordered sequence, (c) receiving, from the particular network element to which the partial-key message was sent, the partial-key message having been modified by a unique private key associated with the particular network element, (d) repeating steps (b) and (c) for each successive network element in the ordered sequence except for a source network element and a destination network element designated by the ordered sequence, and (e) sending the partial-key message to the destination network element. The transport network comprises a plurality of network elements including the hub network element and a plurality of leaf network elements.

### CROSS-REFERENCE TO RELATED APPLICATIONS

This application claims priority to the provisional patent application identified by U.S. Ser. No. 63/394,157, filed Aug. 1, 2022, titled “CP Extensions required for shared DS mode”, the entire content of which is hereby expressly incorporated herein by reference.

### BACKGROUND ART

Optical networking utilizes signals encoded in light to transmit information (e.g., data) as an optical signal in various types of telecommunications networks. Optical networking may be used in relatively short-range networking applications such as in a local area network (LAN) or in long-range networking applications, such as those spanning countries, continents, and/or oceans. Generally, optical networks utilize optical amplifiers, a light source such as lasers or light emitting diodes (LEDs), and wavelength division multiplexing to enable high-bandwidth communication.

Because optical networking involves transmitting data over vast distances, and because various components of the optical network may be controlled or maintained by different parties, it is important to ensure that secure communication channels are established between the nodes of an optical network. Generally, existing point-to-point (P2P) optical networks employ some implementation of symmetric key cryptography as a means of providing a secure method for data transmission. Such implementation may involve, for example, a Diffie-Hellman key exchange or an Elliptic Curve Diffie-Hellman key exchange.

In recent years, point-to-multipoint (P2MP) communication has arisen in optical networking. P2MP is a communication architecture wherein a central hub, acting as a transmitter or source, simultaneously transmits data to multiple remote leaves, which act as receivers or destinations. Further, each of the leaves is able to transmit data to the hub, just as in P2P communication. P2MP is particularly advantageous in scenarios where the same data is to be efficiently communicated to multiple locations. In the context of optical networking, P2MP communication allows for optimized bandwidth utilization, reduced latency, and enhanced data distribution.

Key exchange protocols are generally implemented using one of a number of security association protocols, such as an Internet Key Exchange (IKE) or an IKE Version 2 (IKEv2). Importantly, these security association protocols support perfect forward secrecy, which assures that cryptographic keys will not be compromised even if long-term secrets used in the derivation of the cryptographic keys are compromised.

However, a MACSec Key Exchange (MKA), which is typically used in conjunction with MACSec on Local Area Networks (LANs), supports multi-party key exchange, but does not support perfect forward secrecy. What is needed are methods, systems, and modules to implement security association protocol that supports perfect forward secrecy in a P2MP optical network.

### SUMMARY OF THE INVENTION

Methods, systems, and modules are disclosed that address problems in P2MP optical networks, including the problem of providing a security association protocol that supports perfect forward secrecy in a P2MP optical network.

In one aspect, the present disclosure relates to a module for a hub network element, comprising, for example: one or more processor-readable media storing processor-executable instructions that when executed by one or more processors cause the one or more processors to: (a) generate a partial key for a hub network element in a transport network comprising a plurality of network elements including the hub network element and a plurality of leaf network elements, each of the plurality of network elements having a unique public key and a unique private key, the partial key indicative of the unique public key associated with the hub network element; (b) send a partial-key message to a particular network element of an ordered sequence of the plurality of network elements including a first network element and a last network element, the partial-key message comprising the partial key and defining the ordered sequence, the ordered sequence designating the first network element of the ordered sequence as a source network element and the last network element of the ordered sequence as a destination network element, wherein the first network element of the ordered sequence is the hub network element; (c) receive the partial-key message from the particular network element to which the partial-key message was sent, the partial key of the partial-key message having been modified by the unique private key associated with the particular network element; (d) repeat steps (b) and (c) for each successive network element of the ordered sequence except for the source network element and the destination network element; and (e) send the partial-key message to the destination network element.

In another aspect, the present disclosure relates to a method, comprising, for example: (a) generating, by a hub network element in a transport network, a partial key, the transport network comprising a plurality of network elements including the hub network element and a plurality of leaf network elements, each of the plurality of network elements having a unique public key and a unique private key, the partial key indicative of the unique public key associated with the hub network element; (b) sending, by the hub network element, a partial-key message to a particular network element of an ordered sequence of the plurality of network elements including a first network element and a last network element, the partial-key message comprising the partial key and defining the ordered sequence, the ordered sequence designating the first network element of the ordered sequence as a source network element and the last network element of the ordered sequence as a destination network element, wherein the first network element of the ordered sequence is the hub network element; (c) receiving, by the hub network element, the partial-key message from the particular network element to which the partial-key message was sent, the partial key of the partial-key message having been modified by the unique private key associated with the particular network element; (d) repeating, by the hub network element, steps (b) and (c) for each successive network element of the ordered sequence except for the source network element and the destination network element; and (e) sending, by the hub network element, the partial-key message to the destination network element.

In another aspect, the present disclosure relates to a method, comprising, for example: (a) performing, by a hub network element and a particular leaf network element of a plurality of leaf network elements in a transport network, a cryptographic key exchange, thereby determining an encryption key between the hub network element and the particular leaf network element; (b) encrypting, by the hub network element, an encrypted key message using the encryption key, the encrypted key message including a datapath key; (c) sending, by the hub network element, the encrypted key message to the particular leaf network element; (d) decrypting, by the particular leaf network element, the encrypted key message using the encryption key, and storing, by the particular leaf network element, the datapath key as a shared secret key; (e) repeating steps (a) through (d) for each particular leaf network element of the plurality of leaf network elements; and (f) storing, by the hub network element, the datapath key as the shared secret key.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a block diagram of an exemplary implementation of a transport network constructed in accordance with the present disclosure;

FIG. 2 is a block diagram of an exemplary implementation of a computer system shown in FIG. 1;

FIG. 3 is a data flow diagram of an exemplary implementation of a P2MP module shown in FIG. 1;

FIG. 4A is a data flow diagram of an exemplary implementation of a hub network element shown in FIG. 1 communicatively coupled with a plurality of leaf network elements shown in FIG. 1;

FIG. 4B is another data flow diagram of an exemplary implementation of the hub network element shown in FIG. 1 communicatively coupled with the plurality of leaf network elements shown in FIG. 1;

FIG. 5 is a data flow diagram of an exemplary implementation of the hub network element shown in FIG. 1 communicatively coupled with the plurality of leaf network elements shown in FIG. 1, the leaf network elements belonging to a plurality of encryption groups;

FIG. 6A is a data flow diagram of an exemplary implementation of a plurality of cipher circuits shown in FIG. 3 for the hub network element shown in FIG. 1 communicatively coupled with a plurality of de-cipher circuits shown in FIG. 3 for the plurality of leaf network elements shown in FIG. 1;

FIG. 6B is a data flow diagram of an exemplary implementation of the plurality of de-cipher circuits shown in FIG. 3 for the hub network element shown in FIG. 1 communicatively coupled with a plurality of cipher circuits shown in FIG. 3 for the plurality of leaf network elements shown in FIG. 1;

FIG. 7 is a data flow diagram of an exemplary implementation of the network elements shown in FIG. 1 each being designated as being a part of a plurality of Digital Subcarrier Groups constructed in accordance with the present disclosure;

FIG. 8 is a data flow diagram of an exemplary implementation of a method for performing a multi-party exchange between the hub network element shown in FIG. 1 and the plurality of leaf network elements shown in FIG. 1;

FIG. 9 is a data flow diagram of another exemplary implementation of the method for performing a multi-party exchange shown in FIG. 8 between the hub network element shown in FIG. 1 and the plurality of leaf network elements shown in FIG. 1;

FIG. 10A is a process flow diagram of another exemplary implementation of the method for performing a multi-party exchange shown in FIG. 8 between the hub network element shown in FIG. 1 and the plurality of leaf network elements shown in FIG. 1;

FIG. 10B is a process flow diagram of an exemplary portion of a method for performing the multi-party exchange in accordance with the present disclosure;

FIG. 10C is a process flow diagram of another exemplary portion of a method for performing the multi-party exchange in accordance with the present disclosure; and

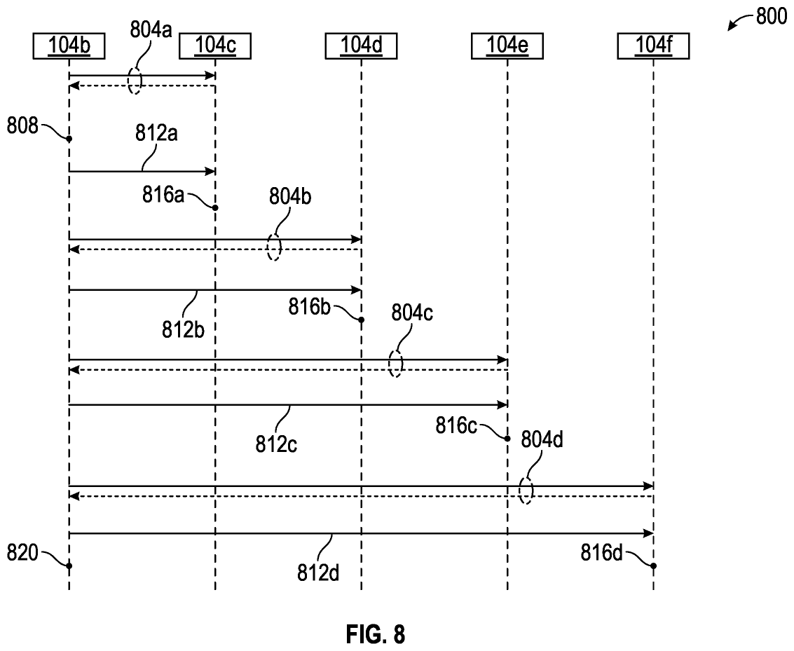

FIC. 11 is a process flow diagram of another exemplary implementation of the method for performing a multi-party exchange shown in FIG. 8 between the hub network element shown in FIG. 1 and the plurality of leaf network elements shown in FIG. 1.

### DETAILED DESCRIPTION

The following detailed description refers to the accompanying drawings. The same reference numbers in different drawings may identify the same or similar elements.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the implementations herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

Finally, as used herein any reference to “one implementation” or “an implementation” means that a particular element, feature, structure, or characteristic described in connection with the implementation is included in at least one implementation. The appearances of the phrase “in one implementation” in various places in the specification are not necessarily all referring to the same implementation.

Referring now to the drawings and in particular to FIG. 1, shown therein is a block diagram of an exemplary implementation of a transport network 100 constructed in accordance with the present disclosure. The transport network 100 comprises a plurality of network elements 104a-n (hereinafter the “network elements 104”), such as the network elements 104a-n, as shown in FIG. 1. One or more of the network elements 104 may be provided with a P2MP module 108. Further, one or more of such network elements 104 may be designated as a hub network element 104b, such as a first network element 104b, as shown in FIG. 1, and one or more of the network elements 104 may be designated as a leaf network element 104, such as a second to “n” network elements 104c-n.

Nonexclusive examples of implementations of the network element 104 include muxponders, optical line terminals (OLTs), optical cross connects (OXCs), optical line amplifiers, routers, optical add/drop multiplexer (OADMs), and/or reconfigurable optical add/drop multiplexers (ROADMs).

Though six network elements 104 are shown for the purposes of illustration, it will be understood that the network elements 104 may comprise a number of network elements 104 more or less than six.

As shown in FIG. 1, the network elements 104 may be communicatively coupled to one another by the optical fiber links 116 extending between them. Each of the optical fiber links 116 may be implemented using one or more lengths of optical fiber and/or equipment interconnecting the optical fiber (e.g., line system components). In some implementations, the optical fiber links 116 collectively define at least a portion of the transport network 100. Particularly, the hub network element 104b may be communicatively coupled to one or more of the leaf network elements 104c-n in a point-to-multipoint configuration. In general, each of the network elements 104 transmits and receives data traffic and control signals.

Data transmitted within the transport network 100 may be transmitted along optical paths formed by a first transmission line segment 112, which may include one or more of the optical fiber links 116a-n (hereinafter the “optical fiber links 116”). For purposes of clarity, only one of the optical fiber links 116 is labeled with a reference character. The transport network 100 may be provided with one or more optical in-line amplifiers (ILA) 120a-n (hereinafter the “ILAs 120”) disposed in the transmission line segment 112, such as a first ILA 120a. Though a single transmission line segment 112 is shown, it will be understood that the transport network 100 may comprise additional transmission line segments 112, such as between additional network elements 104.

In some implementations, a user may interact with a computer system 124 (e.g., via a user device) that may be used to communicate with one or more of the network elements 104 via a communication channel 128. Each element of the computer system 124 may be partially or completely network-based or cloud-based, and may or may not be located in a single physical location. In some implementations, the computer system 124 is connected to one or more network elements 104 via the communication channel 128. In this way, the computer system 124 may communicate with each of the one or more network elements 104 and may, via the communication channel 128, transmit or receive data from each of the one or more network elements 104. In other implementations, the computer system 124 may be integrated into each network element 104 and/or may communicate with one or more pluggable card within the network element 104. In some implementations, the computer system 124 may be a remote network element 104.

The communication channel 128 may permit bi-directional communication of information and/or data between the computer system 124 and/or the network elements 104 of the transport network 100. The communication channel 128 may interface with the computer system 124 and/or the network elements 104 in a variety of ways. In some implementations, the communication channel 128 may interface by optical and/or electronic interfaces, and/or may use a plurality of network topographies and/or protocols including, but not limited to, Ethernet, TCP/IP, circuit switched path, combinations thereof, and/or the like, for example. The communication channel 128 may utilize a variety of network protocols to permit bi-directional interface and/or communication of data and/or information between the computer system 124 and/or the network elements 104.

The communication channel 128 may be a network connection. For example, in some implementations, the communication channel 128 may be a version of an Internet network (e.g., exist in a TCP/IP-based network). In one implementation, the communication channel 128 is the Internet. It should be noted, however, that the communication channel 128 may be almost any type of network and may be implemented as the World Wide Web (or Internet), a local area network (LAN), a wide area network (WAN), a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, combinations thereof, and/or the like, for example.

If the communication channel 128 is the Internet, a primary user interface of the computer system 124 may be delivered through a series of web pages or private internal web pages of a company or corporation, which may be written in hypertext markup language, JavaScript, and/or the like, for example, and accessible by the user. It should be noted that the primary user interface of the computer system 124 may be another type of interface including, but not limited to, a Windows-based application, a tablet-based application, a mobile web interface, a VR-based application, an application running on a mobile device, and/or the like, for example. In one implementation, the communication channel 128 may be connected to one or more of the user devices, computer system 124, and the network elements 104.

The transport network 100 may be, for example, made up of interconnected individual ones of the network elements 104, which may be referred to as “nodes”. The transport network 100 may include any type of network that uses light as a transmission medium. The transport network 100 may include a fiber-optic based network, an optical transport network, a light-emitting diode network, a laser diode network, an infrared network, a wireless optical network, a wireless network, combinations thereof, and/or the like, for example.

As shown in FIG. 1, the P2MP module 108 for the hub network element 104b may generate one or more optical signals and transmit the optical signals (e.g., via the P2MP module 108) to an optical splitter/combiner 132 of the transport network 100. For example, P2MP module 108 for the hub network element 104b may generate an optical signal that is modulated according to multiple sets of optical subcarriers (e.g., Digital Subcarrier Group (DSCG) 1-N), where each set of optical subcarriers is associated with a different one of the leaf network elements 104a-n. Further, the P2MP module 108 for the hub network element 104b may provide the optical signal to the splitter/combiner 132, which may split the optical signal into several power-divided instances of the optical signal. Each of the power-divided instances of the optical signal may be transmitted to a respective one of the leaf network elements 104a-n (e.g., via the optical fiber links 116).

As described in further detail below, the network elements 104 may exchange configuration data and/or commands through one or more general communication channels (GCC) 136 (hereinafter the “GCC 136”). In some implementations, the GCC 136 may include one or more in-band side channels used to carry transmission management and signaling information between the network elements 104. Further, the GCC 136 may support generalized multi-protocol label switching (GMPLS), protection signaling, and network management traffic for the network elements 104. In some implementations, an in-band GCC 136 may be referred to as an IGCC. As described in further detail, the network elements 104 may exchange key messages in the multi-party key exchange through the GCC 136.

In some implementations, the GCC 136 may include one or more out-of-band channels used to carry transmission management and signaling information between the network elements 104. As an example, as described above, data may can be transmitted between two network elements 104 by modulating an optical signal including one or more optical subcarriers, each optical subcarrier being modulated quadrature amplitude (QAM) modulated at a first frequency to carry user data. In some implementations, the optical subcarriers are generated by modulating light output from a laser. In addition, the optical subcarriers can be further modulated (e.g., amplitude modulated or AM modulated) by at one or more second frequencies to carry management and signaling information. In some implementations, the second frequencies may be less than the first frequencies. In some implementations, an out-of-band GCC 136 may be referred to as an XSC3 channel.

Accordingly, the optical subcarriers carry both user information and control information, but the control information may be transmitted at a lower rate than the user information or data. In a further example, selected optical subcarriers may be AM modulated but do not carry user data, while other optical subcarriers are QAM modulated to carry user data, but are not AM modulated and do not carry control information. In some implementations, the GCC 136 may be established directly between the hub network element 104b and one or more of the leaf network elements 104c-n. As described in further detail below, the network elements 104 may exchange key messages in the multi-party key exchange through the GCC 136, and in particular the XSC3 channel. Other communications channels for exchanging configuration data and/or commands are also possible, either instead of or in addition to those described herein. U.S. Pat. No. 11,689,282, “Correcting Traffic Misconnections in Optical Communications Networks”, describes optical subcarriers in more detail and is hereby incorporated in its entirety herein.

The number of devices and/or networks illustrated in FIG. 1 is provided for explanatory purposes. In practice, there may be additional devices and/or networks, fewer devices and/or networks, different devices and/or networks, or differently arranged devices and/or networks than are shown in FIG. 1. Furthermore, two or more of the devices illustrated in FIG. 1 may be implemented within a single device, or a single device illustrated in FIG. 1 may be implemented as multiple, distributed devices. Additionally, or alternatively, one or more of the devices of the transport network 100 may perform one or more functions described as being performed by another one or more of the devices of the transport network 100. Devices of the computer system 124 may interconnect via wired connections, wireless connections, or a combination thereof. For example, in one implementation, the user device and the computer system 124 may be integrated into the same device, that is, the user device may perform functions and/or processes described as being performed by the computer system 124, described below in more detail.

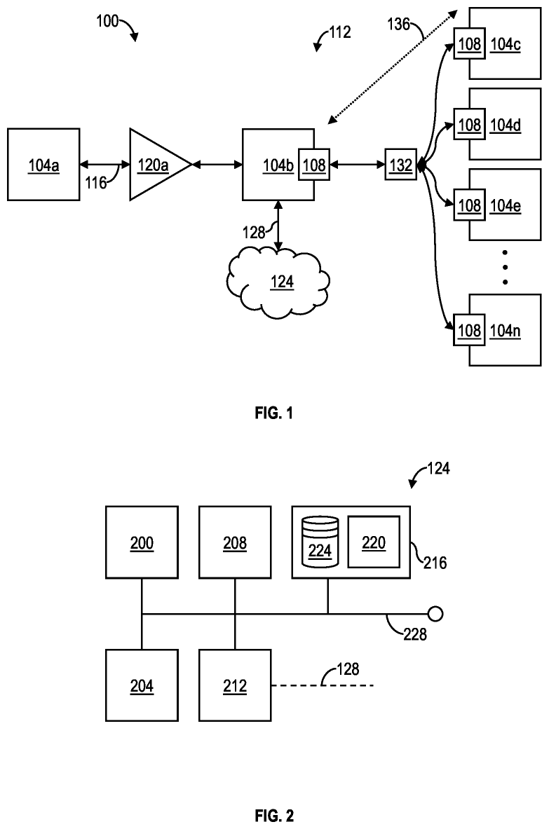

Referring now to FIG. 2, shown therein is a block diagram of an exemplary implementation of the computer system 124 constructed in accordance with the present disclosure. In some implementations, the computer system 124 may include, but is not limited to, implementations as a pluggable computer housed in a network chassis, a personal computer, a cellular telephone, a smart phone, a network-capable television set, a tablet, a laptop computer, a desktop computer, a network-capable handheld device, a server, a digital video recorder, a wearable network-capable device, a virtual reality/augmented reality device, combinations thereof, and/or the like, for example.

In some implementations, the computer system 124 may include one or more input devices 200 (hereinafter the “input device 200”), one or more output devices 204 (hereinafter the “output device 204”), one or more processors 208 (hereinafter the “processor 208”), one or more communication devices 212 (hereinafter the “communication device 212”) capable of interfacing with the communication channel 128, one or more non-transitory processor-readable media (hereinafter the “computer system memory 216”) storing processor-executable code and/or software application(s) 220, including a web browser capable of accessing a website and/or communicating information and/or data over a wireless or wired network (e.g., the communication channel 128), combinations thereof, and/or the like, for example, and a database 224. The input device 200, the output device 204, the processor 208, the communication device 212, and the computer system memory 216 may be connected via a path 228 (e.g., a data bus) that permits communication among the elements of the computer system 124.

In some implementations, the processor 208 may comprise one or more processors 208 working together or independently to read and/or execute processor-executable code and/or data, such as stored in the computer system memory 216. The processor 208 may be capable of creating, manipulating, retrieving, altering, and/or storing data structures into the computer system memory 216. Each element of the computer system 124 may be partially or completely network-based or cloud-based, and may or may not be located in a single physical location.

Implementations of the processor 208 may include, but are not limited to, a digital signal processor (DSP), a central processing unit (CPU), a field programmable gate array (FPGA), a microprocessor, a multi-core processor, an application specific integrated circuit (ASIC), combinations thereof, and/or the like, for example. The processor 208 may be capable of communicating with the computer system memory 216 via the path 228. The processor 208 may be capable of communicating with the input device 200 and/or the output device 204.

The processor 208 may be further capable of interfacing and/or communicating with the network elements 104 via the communication channel 128 using the communication device 212. For example, the processor 208 may be capable of communicating via the communication channel 128 by exchanging signals (e.g., analog, digital, optical, combinations thereof, and/or the like, for example) via one or more ports (e.g., physical or virtual ports) using a network protocol to provide information to the network elements 104.

The computer system memory 216 may store a software application 220 that, when executed by the processor 208, causes the computer system 124 to perform an action such as communicate with, or control, one or more component of the computer system 124, the transport network 100 (e.g., the network elements 104), and/or the communication channel 128.

In some implementations, the computer system memory 216 may have a data store that may store data such as network element version information, firmware version information, sensor data, system data, metrics, logs, tracing, combinations thereof, and/or the like, for example, in a raw format as well as transformed data that may be used for tasks such as reporting, visualization, analytics, signal routing, power loading operations and/or coordination, combinations thereof, and/or the like, for example. The data store may include structured data from relational databases, semi-structured data, unstructured data, time-series data, and binary data. The data store may be a data base, a remote accessible storage, or a distributed filesystem. In some implementations, the data store may be a component of an enterprise network.

In some implementations, the computer system memory 216 may be located in the same physical location as the computer system 124, and/or one or more computer system memories 216 may be located remotely from the computer system 124. For example, the computer system memory 216 may be located remotely from the computer system 124 and communicate with the processor 208 via the communication channel 128. Additionally, when more than one computer system memory 216 is used, a first computer system memory may be located in the same physical location as the processor 208, and one or more additional computer system memories may be located in a location physically remote from the processor 208. Additionally, the computer system memory 216 may be implemented as a “cloud” non-transitory processor-readable storage medium (i.e., one or more of the computer system memories 216 may be partially or completely based on or accessed using the communication channel 128).

In one implementation, the database 224 may be a time-series database, a relational database, or a non-relational database. Implementations of such databases include DB2©, Microsoft® Access, Microsoft® SQL Server, Oracle®, MySQL, PostgreSQL, MongoDB, Apache Cassandra, InfluxDB, Prometheus, Redis, Elasticsearch, TimescaleDB, and/or the like, for example. It should be understood that these examples have been provided for the purposes of illustration only and should not be construed as limiting the presently disclosed inventive concepts. The database 224 may be centralized or distributed across multiple systems.

The input device 200 may be capable of receiving information input from the user, another computer, and/or the processor 208, and transmitting such information to other elements of the computer system 124 and/or the communication channel 128. The input device 200 may include, but is not limited to, implementation as a keyboard, a touchscreen, a mouse, a trackball, a microphone, a camera, a fingerprint reader, an infrared port, a slide-out keyboard, a flip-out keyboard, a cell phone, a PDA, a remote control, a fax machine, a wearable communication device, a network interface, combinations thereof, and/or the like, for example.

The output device 204 may be capable of outputting information in a form perceivable by the user, another computer system, and/or the processor 208. The output device 204 may include, but are is limited to, implementation as a computer monitor, a screen, a touchscreen, a speaker, a website, a television set, a smart phone, a PDA, a cell phone, a fax machine, a printer, a laptop computer, a haptic feedback generator, a network interface, combinations thereof, and/or the like, for example. It is to be understood that in some exemplary implementations, the input device 200 and the output device 204 may be implemented as a single device, such as, for example, a touchscreen of a computer, a tablet, or a smartphone. It is to be further understood that as used herein the term “user” is not limited to a human being, and may comprise a computer, a server, a website, a processor, a network interface, a user terminal, a virtual computer, combinations thereof, and/or the like, for example.

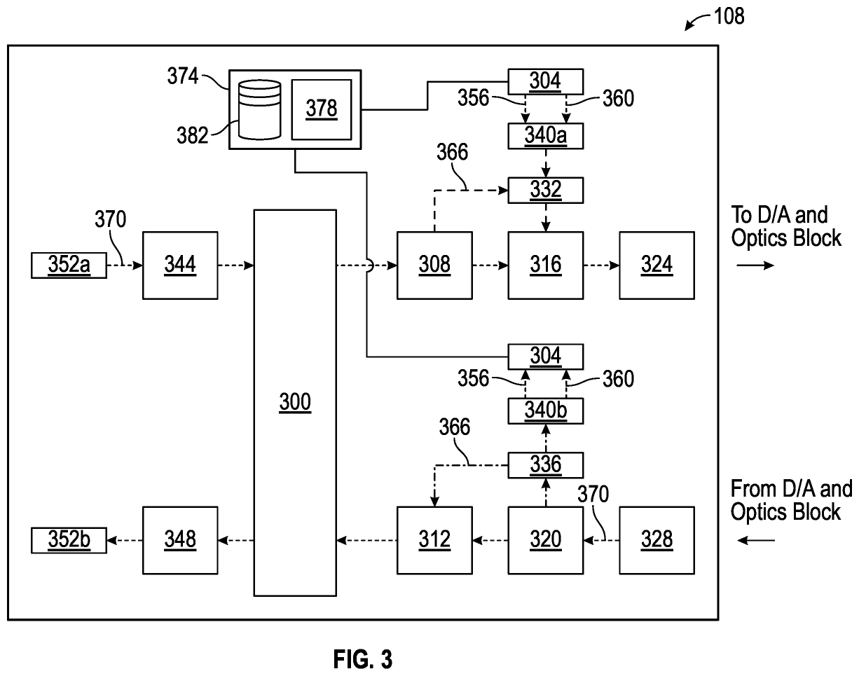

Referring now to FIG. 3, the P2MP module 108 may be configured to transmit and/or receive data via the transport network 100, the optical fiber links 116, and/or the communication channel 128. In some implementations, the P2MP module 108 may be a pluggable device configured to enhance the functionality of the network elements 104. For example, the P2MP module 108 may include a physical communications interface (e.g., a plug or socket) that is configured to reversibly insert into and/or receive corresponding physical communications interface of a network element 104, and exchange information with that network element 104 to facilitate the performance of the operations described herein. In other implementations, the P2MP module 108 may be integral to the network elements 104.

The P2MP module 108 may comprise a switch fabric 300, one or more processors 304 (hereinafter the “processor 304”), a cipher circuit 308, a de-cipher circuit 312, a Forward Error Correction (FEC) mapper 316, a FEC de-mapper 320, a DSP transmitter 324, a DSP receiver 328, an overhead (OH) insertion circuit 332, an OH extraction circuit 336, a multiplexer 340a, a de-multiplexer 340b, one or more client signal mapper circuit 344 (hereinafter the “client signal mapper 344”), one or more client signal de-mapper circuit 348 (hereinafter the “client signal de-mapper 348”), a first client port 352a, and a second client port 352b.

While only one instance of each of the elements of the P2MP module 108 is shown, it should be understood that the P2MP module 108 may comprise a plurality of one or more of the elements described herein. In some implementations, the P2MP module 108 may comprise an instance of one or more of the elements described herein for each optical subcarrier.

As shown in FIG. 3, the processor 304 may provide a management signal 356 and a key exchange signal 360 to the multiplexer 340a, which may multiplex the management signal 356 and the key exchange signal 360 and provide the multiplexed signal to the OH insertion circuit 332. Similarly, the cipher circuit 308 may provide an encryption overhead signal 366 to the OH insertion circuit 332. The encryption overhead signal 366 may include an encryption key (or shared secret key 5), which is discussed in further detail below. In some implementations, the encryption overhead signal 366 may further include an initial vector (IV), additional authenticated data (AAD), or a packet sequence number, for example.

The first client port 352a may be configured to receive a client signal 370 carrying client data from the communication channel 128, for example. Similarly, the second client port 352b may be configured to provide the client signal 370 to the communication channel 128, for example. The first client port 352a and the second client port 352b may each include one or more of a Gigabit Ethernet (GE) interface and an Optical Transport Network (OTN) interface, and may have a granularity of 25 Gbps, for example. The client signal 370 may be, for example, a 100 Gbps signal.

The first client port 352a may provide the client signal 370 to the client signal mapper 344, which may provide the client signal 370 to the switch fabric 300. The switch fabric 300 may provide the client signal 370 to the cipher circuit 308, which may, using the shared secret key 5, encrypt the client data carried by the client signal 370 and provide the client signal 370 carrying the encrypted client data to the FEC mapper 316. The OH insertion circuit 332 may provide data indicative of one or more of the management signal 356, the key exchange signal 360, and the encryption overhead signal 366 to the FEC mapper 316, which may insert the data into an overhead portion of the client signal 370 and provide the client signal 370 to the DSP transmitter 324.

The DSP receiver 328 may provide the client signal 370 to the FEC de-mapper 320, which may extract the data from the overhead portion of the client signal 370 and provide the data to the OH extraction circuit 336. The OH extraction circuit 336 may provide the encryption overhead signal 366 to the de-cipher circuit 312 and may provide a multiplexed signal including the management signal 356 and the key exchange signal 360 to the de-multiplexer 340b, which may de-multiplex the signals and provide the management signal 356 and the key exchange signal 360 to the processor 304.

The FEC de-mapper 320 may provide the client signal 370 to the de-cipher circuit 312, which may, using the shared secret key S, decrypt the client data carried by the client signal 370 and provide the client signal 370 carrying the decrypted client data to the switch fabric 300. The switch fabric 300 may provide the client signal to the client signal de-mapper 348 which may provide the client signal to the second client port 352b.

As shown in FIG. 3, the P2MP module 108 may further comprise one or more non-transitory processor-readable media 374 (hereinafter the “P2MP module memory 374”) storing processor-executable code and/or software application(s) 378, including a multi-party key exchange to be discussed in further detail below, for example, and a database 382. In some implementations, the software application(s) 378 include an expansion of the IKEv2 protocol.

The DSP transmitter 324, the DSP receiver 328, and the network elements 104 are discussed in further detail in U.S. Pat. No. 11,095,364, titled “Frequency Division Multiple Access Optical Subcarriers”, the entire contents of which are hereby expressly incorporated herein by reference.

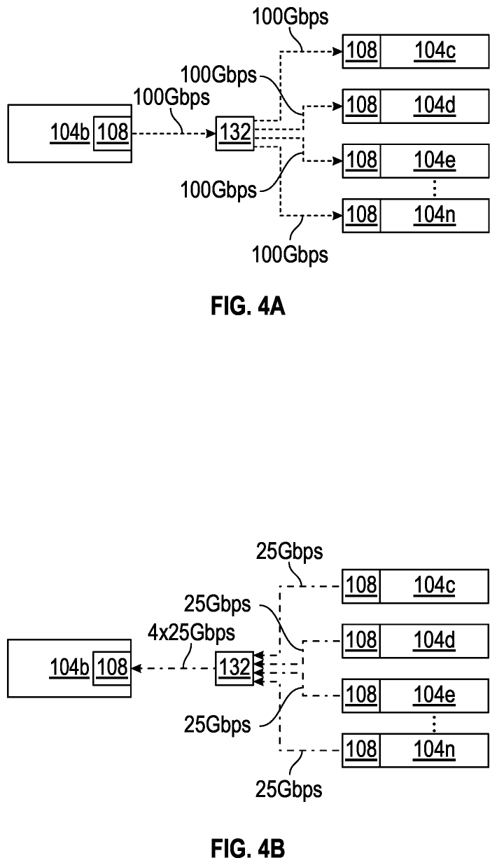

Referring now to FIG. 4A, the hub network element 104b may generate an optical signal that is modulated according to multiple sets of optical subcarriers, where each set of optical subcarriers is associated with a different intended destination for data (e.g., a different one of the leaf network elements 104c-n).

Each of the leaf network elements 104c-n may selectively recover the data stream that is intended for it (e.g., by detecting the optical signals using one or more photodetectors, and demodulate the optical signal according to the set of optical subcarriers that is associated with the leaf network element 104c-n, such as using one or more local oscillators). Further, each of the leaf network elements 104c-n may selectively ignore, block, or otherwise not demodulate the respective optical signal according to the sets of optical subcarriers to which it is not assigned (e.g., such that it refrains from recovering the data that is not intended for it).

As shown in FIG. 4A, in a hub-to-leaf (H2L) direction, the hub network element 104b may transmit the same optical signal to each of the leaf network elements 104c-n. For example, if the total power of the optical signal is Pₜₒₜₐₗ, the power of each of the instances of the optical signal that are transmitted to the leaf network elements 104c-n may be Pₜₒₜₐₗ. In the implementation shown in FIG. 4A, the total power of the optical signal is 100 Gbps, and the power of each of the instances of the optical signal that are transmitted to the leaf network elements 104c-n is 100 Gbps.

Conversely, as shown in FIG. 4B, in a leaf-to-hub (L2H) direction, the leaf network elements 104c-n may transmit a respective power-divided instance of the optical signal to the hub network element 104b. For example, if the total power of the optical signal is Pₜₒₜₐₗ, the power of each of the instances of the optical signal that are transmitted by the leaf network elements 104c-n may be P₁, P₂, . . . , Pn, respectively, where Pₜₒₜₐₗ=P₁+P₂+ . . . +Pn. In the implementation shown in FIG. 4B, the total power of the optical signal is 100 Gbps, and the power of each of the instances of the optical signal that are transmitted by the leaf network elements 104c-n is 25 Gbps.

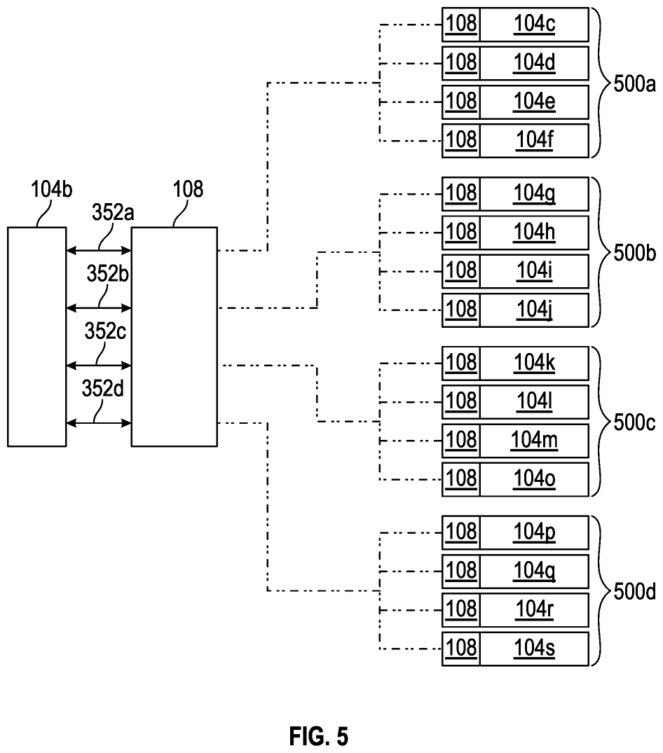

Referring now to FIG. 5, the hub network element 104b may be communicatively coupled to the leaf network elements 104c-n, such as the leaf network elements 104c-s, as shown in FIG. 5. Further, the hub network element 104b may, via the P2MP module 108, designate each of the leaf network elements 104c-n as belonging to one or more encryption group 500a-n (hereinafter the “encryption groups 500”). As shown in FIG. 5, the P2MP module 108 may be provided with a plurality of client ports 352a-n (hereinafter the “client ports 352”), such as client ports 352a-d, wherein each of the client ports 352 supports a particular one of the encryption groups 500.

As shown in FIG. 5, a first encryption group 500a may include leaf network elements 104c-f, a second encryption group 500b may include leaf network elements 104g-j, a third encryption group 500c may include leaf network elements 104k-o, and a fourth encryption group 500d may include leaf network elements 104p-s. The P2MP module 108 for the hub network element 104b may store, maintain, and use a separate encryption key for each of the encryption groups 500.

In some implementations, each of the leaf network elements 104 may determine a particular one of the encryption groups 500 to join when the leaf network elements 104 are brought online. In other implementations, the P2MP module 108 for the hub network element 104b may determine a particular one of the encryption groups 500 for the leaf network elements 104 to join when the leaf network elements 104 are brought online.

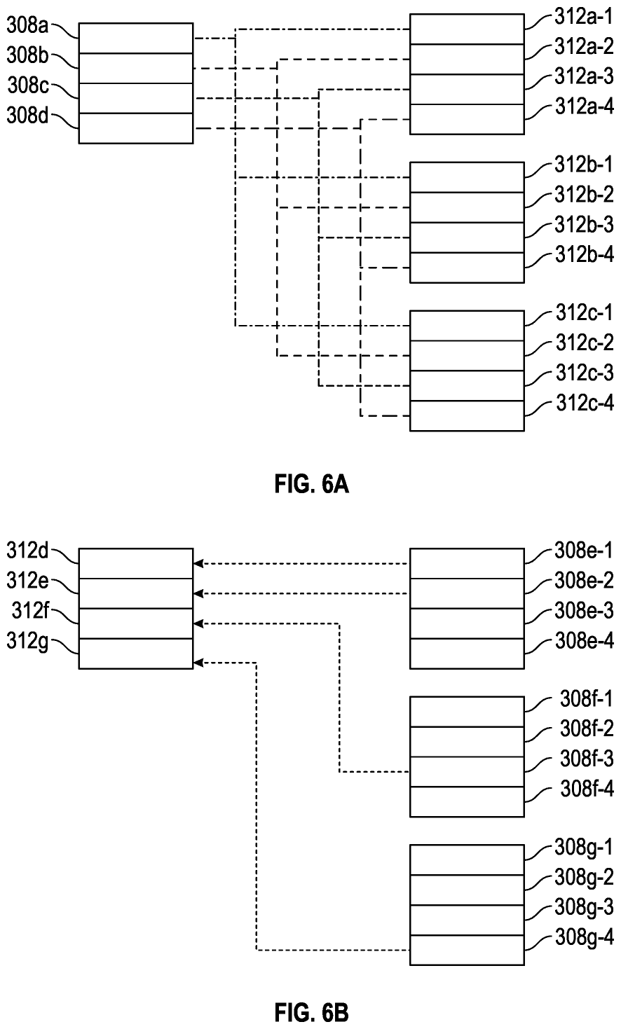

Referring now to FIG. 6A, the P2MP module 108 for the hub network element 104b may include one or more cipher circuits 308a-n (hereinafter the “cipher circuits 308”), such as cipher circuits 308a-d, as shown in FIG. 6A. Further, the P2MP module 108 for each of the leaf network elements 104c-n may include one or more de-cipher circuit 312a-n (hereinafter the “de-cipher circuits 312”), such as de-cipher circuits 312a-1 through 312a-4 for the first leaf network element 104c, de-cipher circuits 312b-1 through 312b-4 for the second leaf network element 104d, and de-cipher circuits 312c-1 through 312c-4 for of the third leaf network element 104e.

Each of the cipher circuits 308 for the hub network element 104b may be communicatively coupled to a particular one of the de-cipher circuits 312 for the leaf network elements 104c-n. In the implementation shown in FIG. 6A, a first cipher circuit 308a is communicatively coupled to first leaf de-cipher circuits 312a-1, 312b-1, and 312c-1; a second cipher circuit 308b is communicatively coupled to second leaf de-cipher circuits 312a-2, 312b-2, and 312c-2; a third cipher circuit 308c is communicatively coupled to third leaf de-cipher circuits 312a-3, 312b-3, and 312c-3; and a fourth cipher circuit 308d is communicatively coupled to fourth leaf de-cipher circuits 312a-4, 312b-4, and 312c-4.

Referring now to FIG. 6B, the P2MP module 108 for the hub network element 104b may include de-cipher circuits 312, such as hub de-cipher circuits 312d-g, as shown in FIG. 6b. Further, the P2MP module 108 for each of the leaf network elements 104c-n may include cipher circuits 308, such as leaf cipher circuits 308e-1 through 308e-4 for the first leaf network element 104c, leaf cipher circuits 308f-1 through 308f-4 for the second leaf network element 104d, and leaf cipher circuits 308g-1 through 308g-4 for of the third leaf network element 104e.

Each of the de-cipher circuits 312 for the hub network element 104b may be communicatively coupled to a particular one of the cipher circuits 308 for the leaf network elements 104c-n. In the implementation shown in FIG. 6B, a first hub de-cipher circuit 312d is communicatively coupled to leaf cipher circuits 308e-1, 308f-1, and 308g-1; a second hub de-cipher circuit 312e is communicatively coupled to leaf cipher circuits 308e-2, 308f-2, and 308g-2; a third hub de-cipher circuit 312f is communicatively coupled to leaf cipher circuits 308e-3, 308f-3, and 308g-3; and a fourth hub de-cipher circuit 312g is communicatively coupled to cipher circuits 308e-4, 308f-4, and 308g-4.

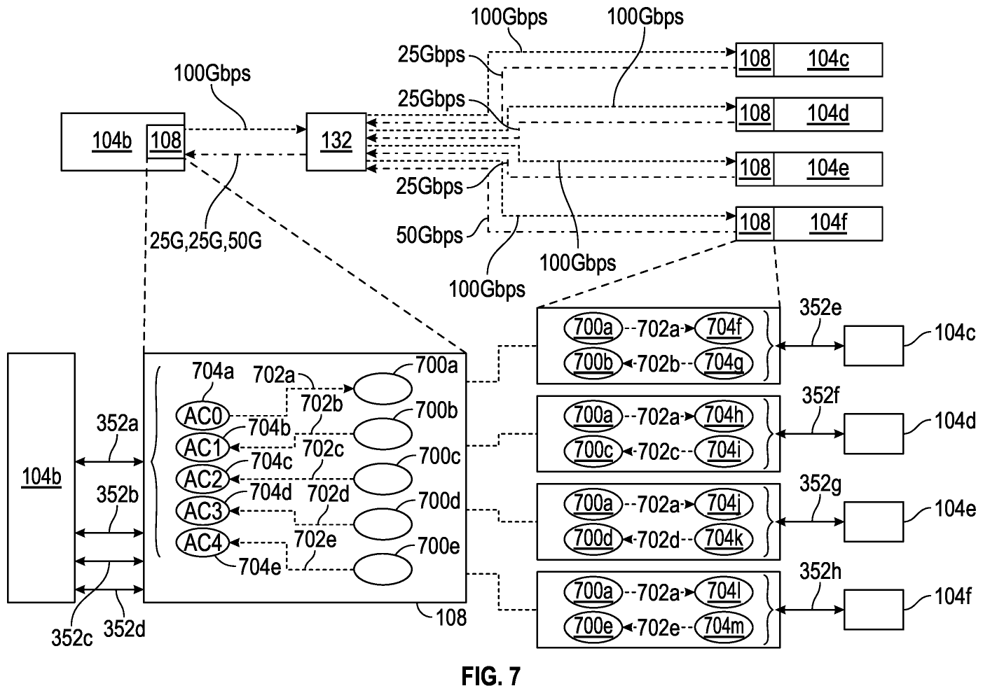

Referring now to FIG. 7, the hub network element 104b may, via the P2MP module 108, designate each of the leaf network elements 104c-n as belonging to one or more DSCG 700a-n (hereinafter the “DSCGs 700”), such as DSCGs 700a-e, as shown in FIG. 7. Each of the DSCGs 700 may be a software entity indicative of a logical grouping of one or more DSCs. In the implementation shown in FIG. 7, a first DSCG 700a represents a logical grouping of four DSCs in the H2L direction, each of the four DSCs being a 25 Gbps optical signal. Further, in the implementation shown in FIG. 7, each of second, third, fourth, and fifth DSCGs 700b-e represent a logical grouping of one DSC in the L2H direction, the DSC being a 25 Gbps optical signal.

As shown in FIG. 7, the hub network element 104b may, via the P2MP module 108, designate each of the leaf network elements 104c-n as belonging to the first DSCG 700a, the first leaf network element 104c as belonging to the second DSCG 700b, the second leaf network element 104d as belonging to the third DSCG 700c, the third leaf network element 104e as belonging to the fourth DSCG 700d, and the fourth leaf network element 104f as belonging to the fifth DSCG 700e.

The hub network element 104b may establish one or more unidirectional cross-connections (XCONs) 702a-n (hereinafter the “XCONs 702”), such as a first, second, third, fourth, and fifth XCONs 702a-e, with each of the leaf network elements 104. Further, the hub network element 104b may, via the P2MP module 108, designate each of the XCONs 702a-n as belonging to one or more attachment circuits (ACs) 704a-n (hereinafter the “ACs 704”), such as a first, second, third, fourth, and fifth ACs 704a-e, as shown in FIG. 7. Each of the ACs 704 may be a software entity indicative of a particular packet flow. Each of the XCONs 702 may be a software entity indicative of a logical association between the ACs 704 and the DSCGs 700. As shown in FIG. 7, each of the leaf network elements 104c-n may, via the P2MP module 108, designate each of the XCONs 702 as belonging to particular ACs 704, such as a sixth and seventh AC 704f-g for the first leaf network element 104c, an eighth and ninth AC 704h-i for the second leaf network element 104d, a tenth and eleventh AC 704j-k for the third leaf network element 104e, and a twelfth and thirteenth AC 704l-m for the fourth leaf network element 104f.

Referring now to FIG. 8, shown therein is a data flow diagram of an exemplary implementation of an exemplary method 800 for performing a multi-party key exchange between the P2MP module 108 for the hub network element 104b and the P2MP module 108 for each of the leaf network elements 104c-n. In some implementations, the steps of the method 800 may be stored as processor-executable instructions (i.e., as one or more of the software application(s) 378) in the P2MP module memory 374 such that, when the processor-executable instructions are performed by the processor 304, for example, the processor-executable instructions may cause the processor 304 to perform one or more steps of the method 800.

As shown in FIG. 8, in some implementations the method 800 may comprise: performing, by the P2MP module 108 for the hub network element 104b and the P2MP module 108 for the first leaf network element 104c, a two-party key exchange, thereby determining a first encryption key K_{ab} for the hub network element 104b and the first leaf network element 104c (step 804a); selecting, by the P2MP module 108 for the hub network element 104b, a datapath key dp-enc-key (e.g., a 256-bit integer) (step 808); sending, by the P2MP module 108 for the hub network element 104b, a first encrypted key message Encrypt(dp-enc-key, K_{ab}) to the first leaf network element 104c, the first encrypted key message Encrypt(dp-enc-key, K_{ab}) including the datapath key dp-enc-key and being encrypted using the first encryption key K_{ab} (step 812a); recovering, by the P2MP module 108 for the first leaf network element 104c, the datapath key dp-enc-key from the first encrypted key message Encrypt(dp-enc-key, K_{ab}) using the first encryption key K_{ab} and storing, by the P2MP module 108 for the first leaf network element 104c, the datapath key dp-enc-key as the shared secret key S in, for example, the P2MP module memory 374 of the P2MP module 108 for the first leaf network element 104c (step 816a).

In some implementations, step 808 of selecting a datapath key may include using, for example, a true random number generator.

As further shown in FIG. 8, in some implementations, the method 800 may further comprise: performing, by the P2MP module 108 for the hub network element 104b and the P2MP module 108 for the second leaf network element 104d, the two-party key exchange, thereby determining a second encryption key K_{ac} for the hub network element 104b and the second leaf network element 104d (step 804b); sending, by the P2MP module 108 for the hub network element 104b, a second encrypted key message Encrypt(dp-enc-key, K_{ac}) to the second leaf network element 104d, the second encrypted key message Encrypt(dp-enc-key, K_{ac}) including the datapath key dp-enc-key and being encrypted using the second encryption key K_{ac} (step 812b); recovering, by the P2MP module 108 for the second leaf network element 104d, the datapath key dp-enc-key from the second encrypted key message Encrypt(dp-enc-key, K_{ac}) using the second encryption key K_{ac} and storing, by the P2MP module 108 for the second leaf network element 104d, the datapath key dp-enc-key as the shared secret key S in, for example, the P2MP module memory 374 of the P2MP module 108 for the second leaf network element 104d (step 816b).

As further shown in FIG. 8, the method 800 may further comprise: performing, by the P2MP module 108 for the hub network element 104b and the P2MP module 108 for the third leaf network element 104e, the two-party key exchange, thereby determining a third encryption key K_{ad} for the hub network element 104b and the third leaf network element 104e (step 804c); sending, by the P2MP module 108 for the hub network element 104b, a third encrypted key message Encrypt(dp-enc-key, K_{ad}) to the P2MP module 108 for the third leaf network element 104e, the third encrypted key message Encrypt(dp-enc-key, K_{ad}) including the datapath key dp-enc-key and being encrypted using the third encryption key K_{ad} (step 812c); recovering, by the P2MP module 108 for the third leaf network element 104e, the datapath key dp-enc-key from the third encrypted key message Encrypt(dp-enc-key, K_{ad}) using the third encryption key K_{ad} and storing, by the P2MP module 108 for the third leaf network element 104e, the datapath key dp-enc-key as the shared secret key S in, for example, the P2MP module memory 374 of the P2MP module 108 for the third leaf network element 104e (step 816c).

As further shown in FIG. 8, the method 800 may further comprise: performing, by the P2MP module 108 for the hub network element 104b and the P2MP module 108 for the fourth leaf network element 104f, the two-party key exchange, thereby determining a fourth encryption key Kₐₑ for the hub network element 104b and the fourth leaf network element 104f (step 804d); sending, by the P2MP module 108 for the hub network element 104b, a fourth encrypted key message Encrypt(dp-enc-key, Kₐₑ) to the fourth leaf network element 104f, the fourth encrypted key message Encrypt(dp-enc-key, Kₐₑ) including the datapath key dp-enc-key and being encrypted using the fourth encryption key Kₐₑ (step 812d); recovering, by the P2MP module 108 for the fourth leaf network element 104f, the datapath key dp-enc-key from the fourth encrypted key message Encrypt(dp-enc-key, Kₐₑ) using the fourth encryption key Kₐₑ and storing, by the P2MP module 108 for the fourth leaf network element 104f, the datapath key dp-enc-key as the shared secret key S in, for example, the P2MP module memory 374 of the P2MP module 108 for the fourth leaf network element 104f (step 816d).

As further shown in FIG. 8, the method 800 may further comprise: storing, by the P2MP module 108 for the hub network element 104b, the datapath key dp-enc-key as the shared secret key S in, for example, the P2MP module memory 374 of the P2MP module 108 for the hub network element 104b (step 820).

Though FIG. 8 shows four leaf network elements 104c-f for purposes of illustration, the method 800 may be used with any number of leaf network elements 104c-n.

In some implementations, the P2MP module 108 for the hub network element 104b and the P2MP module 108 for each of the leaf network elements 104c-n may maintain independent cryptographic associations between the hub network element 104b and each of the leaf network elements 104c-n. In some implementations, the cryptographic associations are Internet Key Exchange Version 2 (IKEv2) associations.

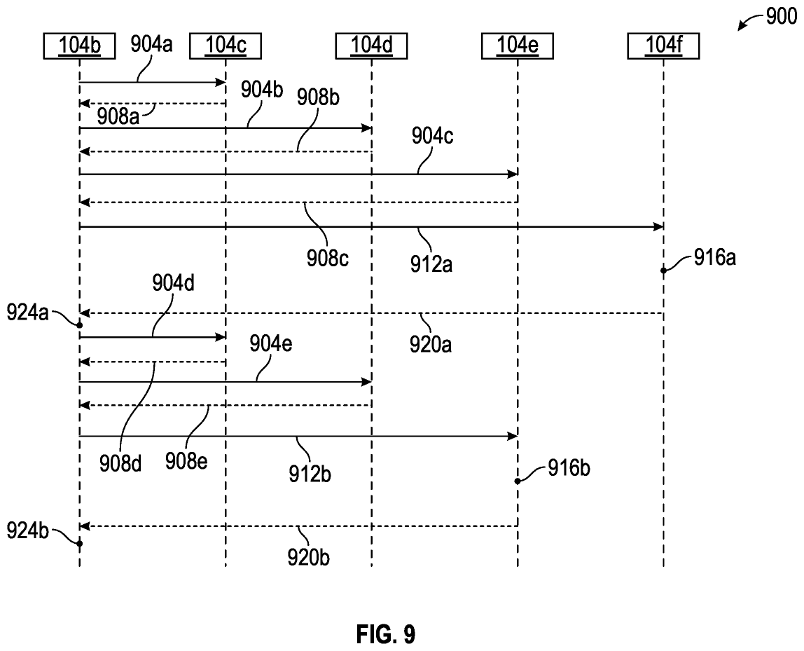

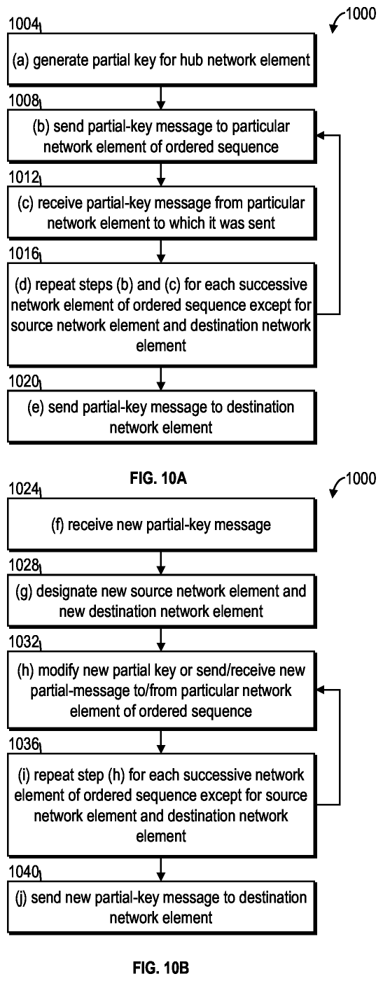

Referring now to FIG. 9, shown therein is a data flow diagram of an exemplary implementation of another method 900 for performing a multi-party key exchange between the P2MP module 108 for the hub network element 104b and the P2MP module 108 for each of the leaf network elements 104c-n. Though FIG. 9 shows four leaf network elements 104c-f for purposes of illustration, the method 900 may be used with any number of leaf network elements 104c-n.

In some implementations, the steps of the method 900 may be stored as processor-executable instructions (i.e., as one or more of the software application(s) 378) in the P2MP module memory 374 such that, when the processor-executable instructions are performed by the processor 304, for example, the processor-executable instructions may cause the processor 304 to perform one or more steps of the method 900.

As an initial step of the method 900, the P2MP module 108 for each particular network element 104 may determine a common prime number p and a common base number g. In some implementations, the common base number g is a primitive root modulo p; however, in other implementations, the common base number g is a point having coordinates (x_{g}, y_{g}) on an elliptic curve. Based on the common prime number p, the P2MP module 108 for the particular network element 104 may determine a unique private key x that is unique to the particular network element 104. The unique private key x for each particular network element 104 may be a random integer between 1 and p−1. Further, based on the common base number g and the unique private key x of the particular network element 104, the P2MP module 108 for the particular network element 104 may determine a unique public key X that is unique to the particular network element 104 associated with the unique private key x. In some implementations, the unique public key X is determined based on g^{x} mod(p). However, it will be understood by persons having ordinary skill in the art that the unique public key X may be determined differently, for example, in implementations of an Elliptic Curve Diffie-Hellman key exchange.

As shown in FIG. 9, the method 900 may comprise: sending, by the P2MP module 108 for the hub network element 104b, a partial-key message Ph(g^{a}, H[1]234) to the P2MP module 108 for the first leaf network element 104c, the partial-key message Ph(g^{a}, H[1]234) comprising a partial key g^{a} (the partial key g^{a} being initially indicative of a unique public key A associated with the hub network element 104b) and defining an ordered sequence O=H1234 of the network elements 104, the ordered sequence O designating a first network element 104 of the ordered sequence O (i.e., H or the hub network element 104b in this implementation) as a source network element 104 and a last network element 104 of the ordered sequence O (i.e., 4 or the fourth leaf network element 104f in this implementation) as a destination network element 104 (step 904a); and receiving, by the P2MP module 108 for the hub network element 104b, the partial-key message Ph(g^{ab}, H1[2]34) from the first leaf network element 104c (i.e., the particular network element 104 to which the partial-key message Ph(g^{a}, H[1]234) was sent), the partial key g^{ab} having been modified by a unique private key b associated with the first leaf network element 104c (step 908a).

As shown in FIG. 9, the method 900 may further comprise: sending, by the P2MP module 108 for the hub network element 104b, the partial-key message Ph(g^{ab}, H1[2]34) to the P2MP module 108 for the second leaf network element 104d (step 904b); receiving, by the P2MP module 108 for the hub network element 104b, the partial-key message Ph(g^{abc}, H12[3]4) from the P2MP module 108 for the second leaf network element 104d (i.e., the particular network element 104 to which the partial-key message Ph(g^{ab}, H1[2]34) was sent), the partial key g^{abc} having been modified by a unique private key c associated with the second leaf network element 104d (step 908b); sending, by the P2MP module 108 for the hub network element 104b, the partial-key message Ph(g^{abc}, H12[3]4) to the P2MP module 108 for the third leaf network element 104e (step 904c); and receiving, by the P2MP module 108 for the hub network element 104b, the partial-key message Ph(g^{abcd}, H123[4]) from the P2MP module 108 for the third leaf network element 104e (i.e., the particular network element 104 to which the partial-key message Ph(g^{abc}, H12[3]4) was sent), the partial key g^{abcd} having been modified by a unique private key d associated with the third leaf network element 104e (step 908c).

As further shown in FIG. 9, the method 900 may further comprise: sending, by the P2MP module 108 for the hub network element 104b, the partial-key message Ph(g^{abcd}, a H123[4]) to the P2MP module 108 for the fourth leaf network element 104f. In some implementations, the method 900 further comprises: modifying, by the P2MP module 108 for the destination network element 104 (i.e., the fourth leaf network element 104f), the partial key g^{abcd} of the partial key message Ph(g^{abcd}, H123[4]) by a unique private key e associated with the fourth leaf network element 104f, and storing, by the P2MP module 108 for the fourth leaf network element 104f, the modified partial key g^{abcde} as a shared secret key S (also referred to herein as a “cryptographic key”) in, for example, the P2MP module memory 374 of the P2MP module 108 for the fourth leaf network element 104f.

As further shown in FIG. 9, the method 900 may further comprise: receiving, by the P2MP module 108 for the hub network element 104b, a new partial-key message Pl(g^{e}) comprising a new partial key g^{e} (the new partial key g^{e} being initially indicative of a unique public key E associated with the destination network element 104 or the fourth leaf network element 104f in this implementation) (step 920a); and designating the particular network element 104 previously designated as the destination network element 104 (i.e., the fourth leaf network element 104f in this implementation) as the source network element 104, and designating a preceding network element 104 of the ordered sequence O=H1234 (i.e., the third leaf network element 104e in this implementation) as the destination network element 104, thereby forming the ordered sequence O=4H123 (step 924a).

As further shown in FIG. 9, the method 900 may further comprise: modifying, by the P2MP module 108 for the hub network element 104b, the new partial key g^{e} by the unique private key a associated with the hub network element 104b, and sending, by the P2MP module 108 for the hub network element 104b, the new partial-key message Ph(g^{ae}, 4H[1]23) to the P2MP module 108 for the first leaf network element 104c (step 904d); receiving, by the P2MP module 108 for the hub network element 104b, the partial-key message Ph(g^{abe}, 4H1[2]3) from the P2MP module 108 for the first leaf network element 104c (i.e., the particular network element 104 to which the partial-key message Ph(g^{ae}, 4H[1]23) was sent), the partial key g^{abe} having been modified by the unique private key b associated with the first leaf network element 104c (step 908d); sending, by the P2MP module 108 for the hub network element 104b, the partial-key message Ph(g^{abe}, 4H1[2]3) to the P2MP module 108 for the second leaf network element 104d (step 904e); and receiving, by the P2MP module 108 for the hub network element 104b, the partial-key message Ph(g^{abce}, 4H12[3]) from the P2MP module 108 for the second leaf network element 104d (i.e., the particular network element 104 to which the partial-key message Ph(g^{abce}, 4H1[2]3) was sent), the partial key g^{abce} having been modified by the unique private key c associated with the second leaf network element 104d (step 908e).

As further shown in FIG. 9, the method 900 may further comprise: sending, by the P2MP module 108 for the hub network element 104b, the partial-key message Ph(g^{abce}, 4H12[3]) to the P2MP module 108 for the third leaf network element 104e. In some implementations, the method 900 further comprises: modifying, by the P2MP module 108 for the destination network element 104 (i.e., the third leaf network element 104e), the partial key g^{abce} of the partial key message Ph(g^{abce}, 4H12[3]) by the unique private key d associated with the third leaf network element 104e, and storing, by the P2MP module 108 for the third leaf network element 104e, the modified partial key g^{abcde} as the shared secret key S in, for example, the P2MP module memory 374 of the P2MP module 108 for the third leaf network element 104e.

As further shown in FIG. 9, the method 900 may further comprise: receiving, by the P2MP module 108 for the hub network element 104b, a new partial-key message Pl(g^{d}) comprising a new partial key g^{d} (the new partial key g^{d} being initially indicative of a unique public key D associated with the destination network element 104 or the third leaf network element 104e in this implementation) (step 920b); and designating the particular network element 104 previously designated as the destination network element 104 (i.e., the third leaf network element 104e in this implementation) as the source network element 104, and designating a preceding network element 104 of the ordered sequence O=4H123 (i.e., the second leaf network element 104d in this implementation) as the destination network element 104, thereby forming the ordered sequence O=34H12 (step 924b).

The method 900 may continue in this manner until the P2MP module 108 for each of the leaf network elements 104c-n has stored the shared secret key S in, for example, the P2MP module memory 374 of the P2MP module 108, after which time the P2MP module 108 for the hub network element 104b may store the shared secret key S in the P2MP module memory 374 of the P2MP module 108.

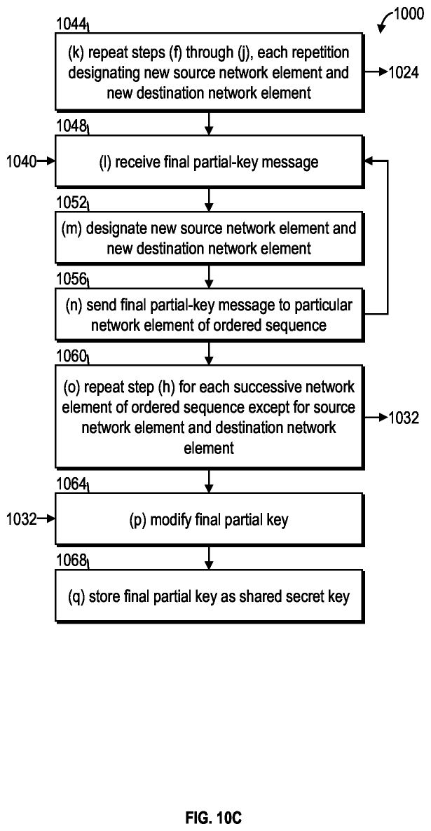

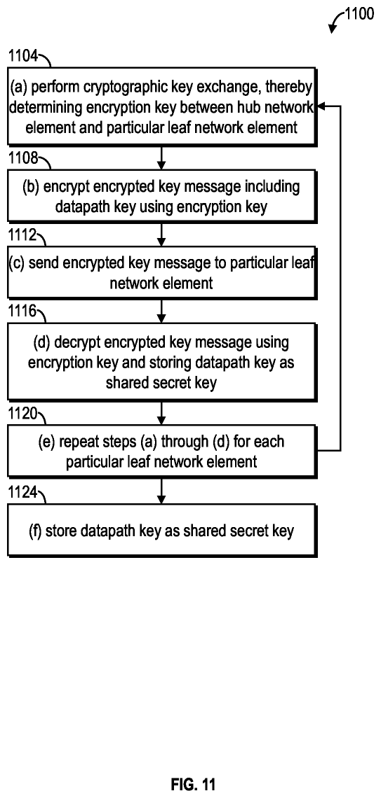

Referring now to FIG. 10A, shown therein is a process flow diagram of an exemplary implementation of another method 1000 for performing the multi-party key exchange between the P2MP module 108 for the hub network element 104b and the P2MP module 108 for each of the leaf network elements 104c-n.

As shown in FIG. 10A, the method 1000 may comprise: (a) generating, by the P2MP module 108 for the hub network element 104b, a partial key g^{a} (the partial key g^{a} being initially indicative of a unique public key A associated with the hub network element 104b) (step 1004); (b) sending, by the P2MP module 108 for the hub network element 104b, the partial-key message Ph(g^{{ . . . }}, O) to a particular network element 104 of the ordered sequence O including a first network element 104 and a last network element 104, the ordered sequence O designating the first network element 104 of the ordered sequence O as the source network element 104 and the last network element 104 of the ordered sequence O as the destination network element 104 (step 1008).

In some implementations, the method 1000 may further comprise, in response to receiving the partial-key message Ph(g^{{ . . . }}, O), modifying, by the P2MP module 108 for the particular network element 104, the partial key g^{{ . . . }} by the unique private key x associated with the particular network element 104, and sending, by the P2MP module 108 for the particular network element 104, the partial-key message Ph(g^{{ . . . }}, O) to the P2MP module 108 for the hub network element 104b.

As further shown in FIG. 10A, in some implementations the method 1000 may further comprise: (c) receiving, by the P2MP module 108 for the hub network element 104b, the partial-key message Ph(g^{{ . . . }}, O) from the P2MP module 108 for particular network element 104 to which the partial-key message Ph(g^{{ . . . }}, O) was sent, the partial key g^{{ . . . }} of the partial-key message Ph(g^{{ . . . }}, O) having been modified by the unique private key x associated with the particular network element 104 (step 1012); and (d) repeating, by the P2MP module 108 for the hub network element, steps (b) and (c) (i.e., steps 1008 and 1012) for each successive network element 104 of the ordered sequence O except for the source network element 104 and the destination network element 104 (step 1016); and (e) sending, by the P2MP module 108 for the hub network element 104b, the partial-key message Ph(g^{{ . . . }}, O) to the destination network element 104 (step 1020).

Referring now to FIG. 10B, in some implementations the method 1000 may further comprise: storing, by the P2MP module 108 for the destination network element 104, the partial key g of the partial-key message Ph(g^{{ . . . }}, O) as the shared secret key S, and sending, by the P2MP module 108 for the destination network element 104, a new partial-key message Pl(g^{x}) comprising a new partial key g^{x} (the new partial key g^{x} being initially indicative of the unique public key X associated with the destination network element 104) to the P2MP module 108 for the hub network element 104b.

As further shown in FIG. 10B, in some implementations the method 100 may further comprise: (f) receiving, by the P2MP module 108 for the hub network element 104b, the new partial-key message Pl(g^{x}) (step 1024). The new partial-key message Pl(g^{x}) may be sent by the P2MP module 108 for the destination network element 104 to the P2MP module 108 for the hub network element 104b.

As further shown in FIG. 10B, in some implementations the method 1000 may further comprise: (g) designating, by the P2MP module 108 for the hub network element 104b, the particular network element 104 previously designated as the destination network element 104 as the source network element 104, and designating a preceding network element 104 of the ordered sequence O as the destination network element 104 (step 1028); (h) when a particular network element 104 of the ordered sequence O is the hub network element 104b, modifying, by the P2MP module 108 for the hub network element 104b, the new partial key g^{{ . . . }} by the unique private key a associated with the hub network element 104b and sending, by the P2MP module 108 for the hub network element 104b, the new partial-key message Ph(g^{{ . . . }}, O) to another particular network element 104 of the ordered sequence O other than the source network element 104 and the destination network element 104 and the hub network element 104b, and when the particular network element 104 of the ordered sequence O is not the hub network element 104b, sending, by the P2MP module 108 for the hub network element 104b, the new partial-key message Ph(g^{{ . . . }}, O) to another particular network element 104 of the ordered sequence O other than the source network element 104 and the destination network element 104 and the hub network element 104b, and receiving, by the P2MP module 108 for the hub network element 104b, the new partial-key message Ph(g^{{ . . . }}, O) from the particular network element 104 to which the new partial-key message Ph(g^{{ . . . }}, O) was sent, the new partial key g^{{ . . . }} of the new partial-key message Ph(g^{{ . . . }}, O) having been modified by the unique private key x associated with the particular network element 104 (step 1032); (i) repeating, by the P2MP module 108 of the hub network element 104b, step (h) (i.e., step 1032) for each successive network element 104 in the ordered sequence O except for the source network element 104 and the destination network element 104; and (j) sending, by the P2MP module 108 for the hub network element 104b, the new partial-key message Ph(g^{{ . . . }}, O) to the destination network element 104 (step 1040).

In some implementations, the method 1000 may further comprise, as a part of step (h) (i.e., step 1032): in response to receiving the new partial-key message Ph(g^{{ . . . }}, O), modifying, by the P2MP module 108 for the particular network element 104, the partial key g^{{ . . . }} by the unique private key x associated with the particular network element 104, and sending, by the P2MP module 108 for the particular network element 104, the partial-key message Ph(g^{{ . . . }}, O) to the P2MP module 108 for the hub network element 104b.

Referring now to FIG. 10C, the method 1000 may further comprise: (k) repeating, by the P2MP module 108 for the hub network element 104b, steps (f) through (j) (i.e., steps 1024 through 1040), in each repetition designating the particular network element 104 previously designated as the destination network element 104 as the source network element 104, and designating a preceding network element 104 of the ordered sequence O as the destination network element 104, until each of the leaf network elements 104c-n has been designated as the destination network element 104 in turn and the hub network element 104b is the preceding network element 104 of the ordered sequence O (step 1044).

As further shown in FIG. 10C, in some implementations the method 1000 may further comprise: storing, by the P2MP module 108 for the destination network element 104, the new partial key g^{{ . . . }} of the new partial-key message Ph(g^{{ . . . }}, O) as the shared secret key S, and sending, by the P2MP module 108 for the destination network element 104, a final partial-key message Pl(g^{x}) comprising a final partial key g^{x} (the final partial key g^{x} being initially indicative of the unique public key X associated with the destination network element 104) to the P2MP module 108 for the hub network element 104b.

As further shown in FIG. 10C, in some implementations the method 1000 may further comprise: (l) receiving, by the P2MP module 108 for the hub network element 104b, the final partial-key message Pl(g^{x}) (step 1048); (m) designating, by the P2MP module 108 for the hub network element 104b, the particular network element 104 previously designated as the destination network element 104 as the source network element 104, and designating the hub network element 104b as the destination network element (step 1052); (n) sending, by the P2MP module 108 for the hub network element 104b, the final partial-key message Ph(g^{{ . . . }}, O) to a particular network element 104 of the ordered sequence O other than the source network element 104 and the destination network element 104 (step 1052); (n) receiving, by the P2MP module 108 for the hub network element 104b, the final partial-key message Ph(g^{{ . . . }}, O) from the particular network element 104 to which the final partial-key message Ph(g^{{ . . . }}, O) was sent, the final partial key g^{{ . . . }} of the final partial-key message Ph(g^{{ . . . }}, O) having been modified by the unique private key x associated with the particular network element 104 (step 1056); (o) repeating, by the P2MP module 108 for the hub network element 104b, step (h) (i.e., step 1032) for each successive network element 104 in the ordered sequence O except for the source network element 104 and the destination network element 104 (step 1060); (p) modifying, by the P2MP module 108 for the hub network element 104b, the final partial key g^{{ . . . }} of the final partial-key message Ph(g^{{ . . . }}, O) by the unique private key a associated with the hub network element 104b (step 1064); and (q) storing, by the P2MP module 108 for the hub network element 104b, the final partial key g^{{ . . . }} of the final partial-key message Ph(g^{{ . . . }}, O) as the shared secret key S (step 1068).

In some implementations, the method 1000 may further comprise, in between step (m) (i.e., step 1052) and step (n) (i.e., step 1056): in response to receiving the final partial-key message Ph(g^{{ . . . }}, O), modifying, by the P2MP module 108 for the particular network element 104, the final partial key g^{{ . . . }} by the unique private key x associated with the particular network element 104, and sending, by the P2MP module 108 for the particular network element 104, the final partial-key message Ph(g^{{ . . . }}, O) to the P2MP module 108 for the hub network element 104b.

In some implementations, the method 1000 may further comprise: (r) receiving, by one or more of the client ports 352 of the P2MP module 108 for the hub network element 104b, client data (i.e., the client signal 370) for communication to one or more of the plurality of leaf network elements 104c-n; (s) encrypting, by the cipher circuit 308 of the P2MP module 108 for the hub network element 104b, the client data (i.e., the client signal 370) using the shared secret key 5; and (t) sending, by the DSP transmitter 324 of the P2MP module 108 for the hub network element 104b, the client data (i.e., the client signal 370) to the P2MP module 108 for one or more of the plurality of leaf network elements 104c-n.

In some implementations, the method 1000 may further comprise: (r) performing, by the P2MP module 108 for the hub network element 104b, a cryptographic key exchange with the P2MP module 108 for a particular leaf network element 104 of the plurality of leaf network elements 104c-n, thereby determining a unicast encryption key Kᵤ between the hub network element 104b and the particular leaf network element 104; (s) receiving, by the DSP receiver 328 of the P2MP module 108 for the hub network element 104b, encrypted client data (i.e., the client signal 370) for communication to the hub network element 104b, the encrypted client data (i.e., the client signal 370) having been encrypted by the particular leaf network element 104 using the unicast encryption key Kᵤ; and (t) decrypting, by the de-cipher circuit 312 of the P2MP module 108 for the hub network element 104b, the encrypted client data (i.e., the client signal 370) using the unicast encryption key Kᵤ. In some implementations, one or more of steps (r) through (t) may be performed for each of the plurality of leaf network elements 104c-n in the transport network 100.

In some implementations, the method 1000 may further comprise: before step (a) (i.e., step 1004), determining, by the P2MP module 108 for the hub network element 104b, one or more of: a new leaf network element 104 has been added to the plurality of leaf network elements 104c-n; and a particular one of the plurality of leaf network elements 104c-n has been removed from the plurality of leaf network elements 104c-n. In response, the P2MP module 108 for the hub network element 104b may perform a member discovery protocol to determine the current state of the transport network 100.

In some implementations, the method 1000 may further comprise: detecting, by the P2MP module 108 for the hub network element 104b, a failure of one or more of the plurality of leaf network elements 104c-n; and after waiting a pre-determined time period, performing, by the hub network element 104b, one or more of steps (a) through (e) (i.e., steps 1004 through 1020).

Referring now to FIG. 11, shown therein shown therein is a process flow diagram of an exemplary implementation of another method 1100 for performing the multi-party key exchange between the P2MP module 108 for the hub network element 104b and the P2MP module 108 for each of the leaf network elements 104c-n.

As shown in FIG. 11, the method 1100 may comprise: (a) performing, by the P2MP module 108 for the hub network element 104b and the P2MP module 108 for a particular leaf network element 104n, a cryptographic key exchange, thereby determining an encryption key K between the hub network element 104b and the particular leaf network element 104n (step 1104); (b) encrypting, by the P2MP module 108 for the hub network element 104b, an encrypted key message Encrypt(dp-enc-key, K) using the encryption key K, the encrypted key message Encrypt(dp-enc-key, K) including a datapath key dp-enc-key (step 1108); (c) sending, by the P2MP module 108 for the hub network element 104b, the encrypted key message Encrypt(dp-enc-key, K) to the particular leaf network element 104n (step 1112); (d) decrypting, by the P2MP module 108 for the particular leaf network element 104n, the encrypted key message Encrypt(dp-enc-key, K) using the encryption key K, and storing, by the particular leaf network element 104n, the datapath key dp-enc-key as a shared secret key S (step 1116); (e) repeating steps (a) through (d) for each particular leaf network element 104n of the plurality of leaf network elements 104c-n (step 1120); and (f) storing, by the P2MP module 108 for the hub network element 104b, the datapath key dp-enc-key as the shared secret key S.

In some implementations, the method 1100 may further comprise: (g) receiving, by one or more of the client ports 352 of the P2MP module 108 for the hub network element 104b, client data (i.e., the client signal 370) for communication to one or more of the plurality of leaf network elements 104c-n; (h) encrypting, by the cipher circuit 308 of the P2MP module 108 for the hub network element 104b, the client data (i.e., the client signal 370) using the shared secret key S; and (i) sending, by the DSP transmitter 324 of the P2MP module 108 for the hub network element 104b, the client data (i.e., the client signal 370) to the P2MP module 108 for one or more of the plurality of leaf network elements 104c-n.

In some implementations, the cryptographic key exchange may be a first cryptographic key exchange, the encryption key K may be a multicast encryption key Kₘ, and the method 1100 may further comprise: (g) performing, by the P2MP module 108 for the hub network element 104b and the P2MP module 108 for a particular leaf network element 104 of the plurality of leaf network elements 104c-n, a second cryptographic key exchange, thereby determining a unicast encryption key Kᵤ between the hub network element 104b and the particular leaf network element 104; (h) receiving, by the DSP receiver 328 of the P2MP module 108 for the hub network element 104b, encrypted client data (i.e., the client signal 370) for communication to the hub network element 104b, the encrypted client data (i.e., the client signal 370) having been encrypted by the particular leaf network element 104 using the unicast encryption key Kᵤ; and (i) decrypting, by the de-cipher circuit 312 of the P2MP module 108 for the hub network element 104b, the encrypted client data (i.e., the client signal 370) using the unicast encryption key Kᵤ. In some implementations, one or more of steps (g) through (i) may be performed for each of the plurality of leaf network elements 104c-n in the transport network 100.

It should be understood that one or more of the methods 800, 900, 1000, 1100 described herein may be implemented in a manner conforming to an established encryption standard, such as an Advanced Encryption Standard (AES). Further, each of the methods 800, 900, 1000, 1100 may be performed to determine a first shared secret key S₁ fora first DSC, wherein determining shared secret keys S₂₋ₙ for a plurality of additional DSCs may include performing a key expansion algorithm, as is known in the art.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred implementation. Further, the phrase “based on” is intended to mean “based, at least in part, on” unless explicitly stated otherwise.

What is claimed is:

1. A module for a hub network element, comprising:
one or more processor-readable media storing processor-executable instructions that when executed by one or more processors cause the one or more processors to:
(a) generate a partial key for a hub network element in a transport network comprising a plurality of network elements including the hub network element and a plurality of leaf network elements, each of the plurality of network elements having a unique public key and a unique private key, the partial key indicative of the unique public key associated with the hub network element;
(b) send a partial-key message to a particular network element of an ordered sequence of the plurality of network elements including a first network element and a last network element, the partial-key message comprising the partial key and defining the ordered sequence, the ordered sequence designating the first network element of the ordered sequence as a source network element and the last network element of the ordered sequence as a destination network element, wherein the first network element of the ordered sequence is the hub network element;
(c) receive the partial-key message from the particular network element to which the partial-key message was sent, the partial key of the partial-key message having been modified by the unique private key associated with the particular network element;
(d) repeat steps (b) and (c) for each successive network element of the ordered sequence except for the source network element and the destination network element; and
(e) send the partial-key message to the destination network element.

2. The module of claim 1, wherein the processor-executable instructions when executed by the one or more processors further cause the one or more processors to:
(f) receive a new partial-key message comprising a new partial key indicative of the unique public key associated with the destination network element;
(g) designate the particular network element previously designated as the destination network element as the source network element, and designate a preceding network element of the ordered sequence as the destination network element;
(h) when a particular network element of the ordered sequence is the hub network element, modify the new partial key by the unique private key associated with the hub network element and send the new partial-key message to another particular network element of the ordered sequence other than the source network element and the destination network element and the hub network element, and when the particular network element of the ordered sequence is not the hub network element, send the new partial-key message to another particular network element of the ordered sequence other than the source network element and the destination network element and the hub network element, and receive the new partial-key message from the particular network element to which the new partial-key message was sent, the new partial key of the new partial-key message having been modified by the unique private key associated with the particular network element;
(i) repeat step (h) for each successive network element of the ordered sequence except for the source network element and the destination network element; and
(j) send the new partial-key message to the destination network element.

3. The module of claim 2, wherein the processor-executable instructions when executed by the one or more processors further cause the one or more processors to:
(k) repeat steps (f) through (j), in each repetition designating the particular network element previously designated as the destination network element as the source network element, and designating a preceding network element of the ordered sequence as the destination network element, until each of the leaf network elements has been designated as the destination network element in turn and the hub network element is the preceding network element of the ordered sequence;
(l) receive a final partial-key message comprising a final partial key indicative of the unique public key associated with the destination network element;
(m) designate the particular network element previously designated as the destination network element as the source network element, and designate the hub network element as the destination network element;
(n) send the final partial-key message to a particular network element of the ordered sequence other than the source network element and the destination network element;
(n) receive the final partial-key message from the particular network element to which the final partial-key message was sent, the final partial key of the final partial-key message having been modified by the unique private key associated with the particular network element;
(o) repeat step (h) for each successive network element of the ordered sequence except for the source network element and the destination network element;
(p) modify the final partial key of the final partial-key message by the unique private key associated with the hub network element; and
(q) store the final partial key of the final partial-key message as a shared secret key.

4. The module of claim 3, wherein the processor-executable instructions when executed by the one or more processors further cause the one or more processors to:
(r) receive client data for communication to one or more of the plurality of leaf network elements;
(s) encrypt the client data using the shared secret key; and
(t) send the client data to the one or more of the plurality of leaf network elements.

5. The module of claim 3, wherein the processor-executable instructions when executed by the one or more processors further cause the one or more processors to:
(r) perform a cryptographic key exchange with a first leaf network element of the plurality of leaf network elements, thereby determining a unicast encryption key between the hub network element and the first leaf network element;
(s) receive encrypted client data for communication to the hub network element, the encrypted client data having been encrypted by the first leaf network element using the unicast encryption key; and
(t) decrypt the encrypted client data using the unicast encryption key.

6. The module of claim 1, wherein the hub network element is communicatively coupled to each of the plurality of leaf network elements in a point-to-multipoint configuration.

7. The module of claim 6, wherein the plurality of leaf network elements is a first plurality of leaf network elements belonging to a first encryption group, and the hub network element is further communicatively coupled to a second plurality of leaf network elements belonging to a second encryption group in a point-to-multipoint configuration.

8. The module of claim 1, wherein the processor-executable instructions when executed by the one or more processors further cause the one or more processors to:
before step (a), determine one or more of: a new leaf network element has been added to the plurality of leaf network elements; and a particular one of the plurality of leaf network elements has been removed from the plurality of leaf network elements.

9. The module of claim 1, wherein the processor-executable instructions when executed by the one or more processors further cause the one or more processors to:
detect a failure of one or more of the plurality of leaf network elements; and
after waiting a pre-determined time period, perform one or more of steps (a) through (e).

10. The module of claim 1, wherein the partial-key message is sent and received via one or more general communication channels.

11. A method, comprising:
(a) generating, by a hub network element in a transport network, a partial key, the transport network comprising a plurality of network elements including the hub network element and a plurality of leaf network elements, each of the plurality of network elements having a unique public key and a unique private key, the partial key indicative of the unique public key associated with the hub network element;
(b) sending, by the hub network element, a partial-key message to a particular network element of an ordered sequence of the plurality of network elements including a first network element and a last network element, the partial-key message comprising the partial key and defining the ordered sequence, the ordered sequence designating the first network element of the ordered sequence as a source network element and the last network element of the ordered sequence as a destination network element, wherein the first network element of the ordered sequence is the hub network element;
(c) receiving, by the hub network element, the partial-key message from the particular network element to which the partial-key message was sent, the partial key of the partial-key message having been modified by the unique private key associated with the particular network element;
(d) repeating, by the hub network element, steps (b) and (c) for each successive network element of the ordered sequence except for the source network element and the destination network element; and
(e) sending, by the hub network element, the partial-key message to the destination network element.

12. The method of claim 11, further comprising:
(f) receiving, by the hub network element, a new partial-key message comprising a new partial key indicative of the unique public key associated with the destination network element;
(g) designating, by the hub network element, the particular network element previously designated as the destination network element as the source network element, and designating a preceding network element of the ordered sequence as the destination network element;
(h) when a particular network element of the ordered sequence is the hub network element, modifying, by the hub network element, the new partial key by the unique private key associated with the hub network element and sending the new partial-key message to another particular network element of the ordered sequence other than the source network element and the destination network element and the hub network element, and when the particular network element of the ordered sequence is not the hub network element, sending, by the hub network element, the new partial-key message to another particular network element of the ordered sequence other than the source network element and the destination network element and the hub network element, and receiving, by the hub network element, the new partial-key message from the particular network element to which the new partial-key message was sent, the new partial key of the new partial-key message having been modified by the unique private key associated with the particular network element;
(i) repeating, by the hub network element, step (h) for each successive network element in the ordered sequence except for the source network element and the destination network element; and
(j) sending, by the hub network element, the new partial-key message to the destination network element.

13. The method of claim 12, further comprising:
(k) repeating, by the hub network element, steps (f) through (j), in each repetition designating the particular network element previously designated as the destination network element as the source network element, and designating a preceding network element of the ordered sequence as the destination network element, until each of the leaf network elements has been designated as the destination network element in turn and the hub network element is the preceding network element of the ordered sequence;
(l) receiving, by the hub network element, a final partial-key message comprising a final partial key indicative of the unique public key associated with the destination network element;
(m) designating, by the hub network element, the particular network element previously designated as the destination network element as the source network element, and designating the hub network element as the destination network element;
(n) sending, by the hub network element, the final partial-key message to a particular network element of the ordered sequence other than the source network element and the destination network element;
(n) receiving, by the hub network element, the final partial-key message from the particular network element to which the final partial-key message was sent, the final partial key of the final partial-key message having been modified by the unique private key associated with the particular network element;
(o) repeating, by the hub network element, step (h) for each successive network element in the ordered sequence except for the source network element and the destination network element;
(p) modifying, by the hub network element, the final partial key of the final partial-key message by the unique private key associated with the hub network element; and
(q) storing, by the hub network element, the final partial key of the final partial-key message as a shared secret key.

14. The method of claim 13, further comprising:
(r) receiving, by the hub network element, client data for communication to one or more of the plurality of leaf network elements;
(s) encrypting, by the hub network element, the client data using the shared secret key; and
(t) sending, by the hub network element, the client data to the one or more of the plurality of leaf network elements.

15. The method of claim 13, wherein the method further comprises:
(r) performing, by the hub network element and a first leaf network element of the plurality of leaf network elements, a cryptographic key exchange, thereby determining a unicast encryption key between the hub network element and the first leaf network element;
(s) receiving, by the hub network element, encrypted client data for communication to the hub network element, the encrypted client data having been encrypted by the first leaf network element using the unicast encryption key; and
(t) decrypting, by the hub network element, the encrypted client data using the unicast encryption key.

16. The method of claim 11, further comprising:
before step (a), determining, by the hub network element, one or more of: a new leaf network element has been added to the plurality of leaf network elements; and a particular one of the plurality of leaf network elements has been removed from the plurality of leaf network elements.

17. The method of claim 11, further comprising:
detecting, by the hub network element, a failure of one or more of the plurality of leaf network elements; and
after waiting a pre-determined time period, performing, by the hub network element, one or more of steps (a) through (e).

18. A method, comprising:
(a) performing, by a hub network element and a particular leaf network element of a plurality of leaf network elements in a transport network, a cryptographic key exchange, thereby determining an encryption key between the hub network element and the particular leaf network element;
(b) encrypting, by the hub network element, an encrypted key message using the encryption key, the encrypted key message including a datapath key;
(c) sending, by the hub network element, the encrypted key message to the particular leaf network element;
(d) decrypting, by the particular leaf network element, the encrypted key message using the encryption key, and storing, by the particular leaf network element, the datapath key as a shared secret key;
(e) repeating steps (a) through (d) for each particular leaf network element of the plurality of leaf network elements; and
(f) storing, by the hub network element, the datapath key as the shared secret key.

19. The method of claim 18, further comprising:
(g) receiving, by the hub network element, client data for communication to one or more of the plurality of leaf network elements;
(h) encrypting, by the hub network element, the client data using the shared secret key; and
(i) sending, by the hub network element, the encrypted client data to the one or more of the plurality of leaf network elements.

20. The method of claim 18, wherein the encryption key is a multicast encryption key, the cryptographic key exchange is a first cryptographic key exchange, and the method further comprises:
(g) performing, by the hub network element and a first leaf network element, a second cryptographic key exchange, thereby determining a unicast encryption key between the hub network element and the first leaf network element;
(h) receiving, by the hub network element, encrypted client data for communication to the hub network element, the encrypted client data having been encrypted by the first leaf network element using the unicast encryption key; and
(i) decrypting, by the hub network element, the encrypted client data using the unicast encryption key.
